(19) United States
(12) Patent Application Publication
(10) Pub. No.: US 2007/0202317 A1
(43) Pub. Date: Aug. 30, 2007

(54) Information Carrier Comprising Concealed Information, For arranging On An Object

(75) Inventors: Niels Raeder, Muenchen (DE); Oliver Berger, Muenchen (DE)

Correspondence Address: MILDE & HOFFBERG, LLP, 10 BANK STREET, SUITE 460, WHITE PLAINS, NY, 10606, US

(73) Assignee: FORTUNE PRODUCTS HOLDING AG, ZUG (CH)

(21) Appl. No.: 11/659,272

(22) PCT Filed: Aug. 2, 2005
(86) PCT No.: PCT/DE05/01359

§ 371 Date: Mar. 12, 2007

(30) Foreign Application Priority Data
Aug. 2, 2004 (DE) 10 2004 037 451.1
Aug. 27, 2004 (DE) 10 2004 041 442.4
Sep. 17, 2004 (DE) 10 2004 045 184.2

(51) Int. Cl. B31F 1/12; B32B 3/26; B32B 7/12

(52) U.S. Cl. 428/322.2; 162/112; 428/343

(57) ABSTRACT

An information carrier with concealed information (23) for attachment to an object (1) is disclosed. The information carrier (2) comprises a front side (21) and a back side (22), with the back side having both a first area and a second area thereof that may be removably attached to each other. The first area of the information carrier (2) includes the concealed information (23) that is completely covered by the second area (26), rendering it invisible when the two areas are attached.

### BACKGROUND OF THE INVENTION

The invention relates to an information carrier with concealed data for mounting on an object.

Various objects are known that carry concealed data in the form of advertising, a lottery number, or the like within, for example, a hollow cavity. For example, reference is made to a candy bar as disclosed in DE 103 11 179.4 that contains a information carrier within a hollow cavity, access to which is first obtained by breaking open the candy bar. Acceptance of such candy bars is increased because the user has an interest in obtaining access to the concealed information after eating the candy bar.

The German Patent Specification DE 203 13 602 U1 describes a soda bread in the form of a so-called “pretzel” that contains within itself a slip of paper. The paper, upon which information is printed, is completely encased in the dough forming the pretzel. Access to the slip of paper is only possible when the pretzel is broken open for eating. There is a problem with this arrangement in that children, in particular, might swallow the slip of paper while eating the pretzel, causing a health hazard. Also, the baking of a printed slip into the dough of a pretzel is not without problems with respect to nutrition laws.

### SUMMARY OF THE INVENTION

It is the principal object of this invention to produce a information carrier with concealed information that may be mounted onto an object without difficulty.

This object is achieved, according to the invention, by providing an information carrier with concealed information for attachment to an object, the information carrier comprising a front side and a back side, with the back side having both a first area and a second area that may be removably attached to each other. According to the invention, the first area of the information carrier includes the concealed information that is completely covered by the second area, rendering it invisible when the two areas are attached to each other.

The main advantage of the invention is the fact that the information carrier need not be positioned within a hollow cavity of an object such as a pretzel or other baked item. Instead, the information carrier, which is preferably configured as a band-shaped part, may be attached to the exterior of, for example, a pretzel, whereby the information becomes visible only after parts of the information carrier or of the band-shaped part are separated. The previously-described health hazard to humans, particularly children, is advantageously avoided because the information carrier is advantageously mounted on the exterior of the object, and is therefore visible. An additional significant advantage of the invention is the fact that the information carrier may be attached to the object so that it may not become lost, and so that the manufacture of the object itself is possible using known manufacturing processes. Inclusion of a hollow cavity within the object to receive the information carrier is not required. In contrast to the prior art, mounting the information carrier based on the invention on a baked item such as, for example, a pretzel, presents no legal nutrition considerations.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic representation of pretzel provided with the information carrier based on the invention whereby the concealed information of the information carrier is not visible.

FIG. 2 is a configuration as in FIG. 1 whereby the information carrier is partially opened in order to provide access to the concealed information.

FIG. 3 is a configuration as in FIG. 1 whereby the information carrier is completely open so that the concealed information is visible.

FIGS. 4-7 illustrate further embodiments of the invention.

### DESCRIPTION OF THE PREFERRED EMBODIMENTS

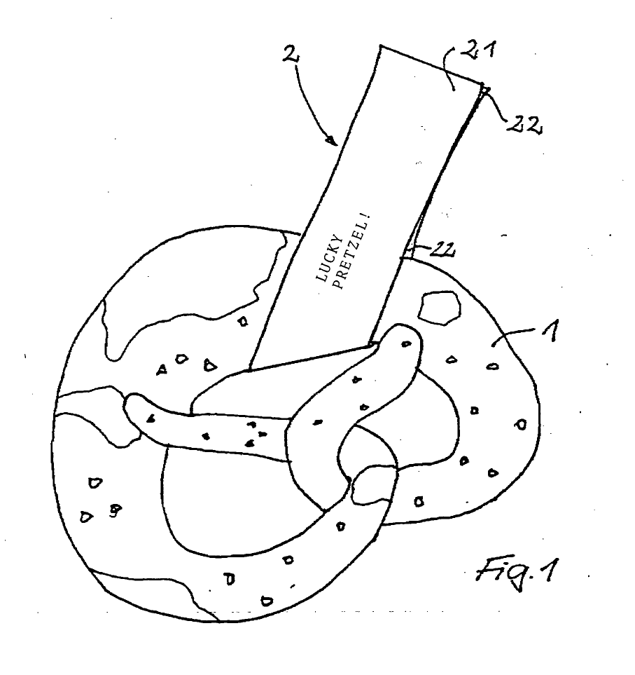

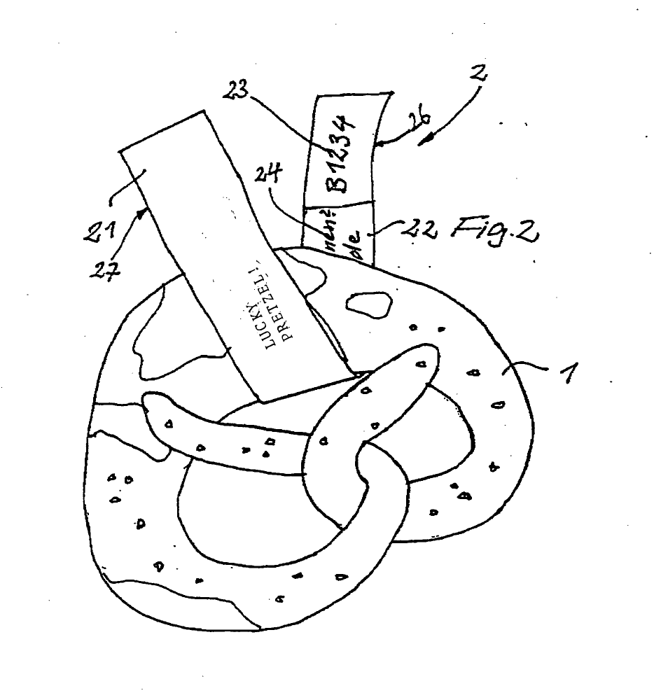

The preferred embodiments of the present invention will now be described with reference to FIGS. 1-7 of the drawings. Identical elements in the various figures are designated with the same reference numerals.

FIG. 1 shows the object provided with this information carrier 2, preferably a baked item in the shape of a pretzel 1. It must be mentioned that the object 1 may be any object whose acceptability is to be increased.

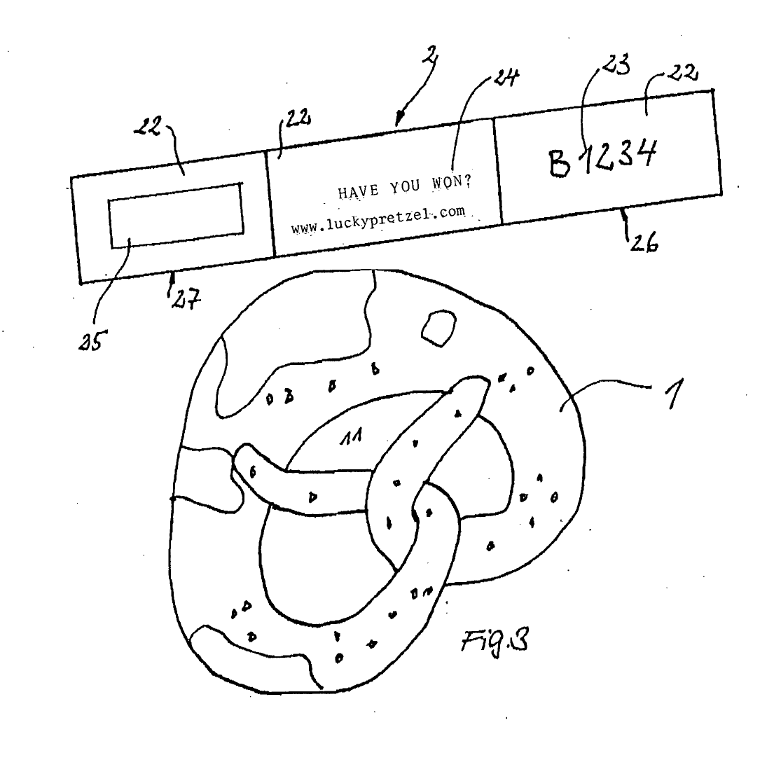

This information carrier 2 preferably is in the form of a band-shaped part whose front side is designated with the index 21 in each of FIGS. 1 through 3. The back side of the band-shaped part is designated with the index 22. The information carrier 2 preferably consists of paper, cardboard, or plastic. As is best visible from FIG. 3, the band-shaped part includes concealed information 23 on its back side 22 essentially in a first end area 26 that consists in this case of the ‘lucky number’ ‘B 1234.’ Instead of the lucky number “B 1234,” the concealed information 23 may be any other type of information, for example a humorous slogan, an image, a photograph, or similar, or may involve an advertising slogan etc., whereby the concealed information 23 may be limited to a specific target group of shoppers. For example, the concealed information 23 may be targeted at visitors to a local county fair or event like the Oktoberfest in Munich. In the case of the lucky number “B 1234” that designates, for example, a specific property or cash reward that is to be won in a lottery, the possessor of the pretzel 1 automatically becomes a participant in a lottery.

On the second end 27 of the band-shaped part opposite the end containing the concealed information 23, an area 25 is, for example located which has an adhesive layer that is of such dimensions that it completely covers the vb1 23, preferably completely, when the two end areas 26 and 27 of the band rest one upon the other and are adhered together. The end area 25 with the adhesive layer thus achieves a releasable bond with the end area 26.

To attach the information carrier 2 to the pretzel 1, the band-shaped part is guided through an opening in the pretzel 1 and wrapped around one part of the pretzel 1, whereby the front side 21 bearing the text “Good-luck pretzel” is positioned to be outward, and the back side 22 is positioned facing inward. When the inner surfaces of the end areas 26 and 27 of the band-shaped parts are pressed together, the end area 25 is adhered to the end area 26 bearing the concealed information 23 so that it may be released, whereby the concealed information 23 is covered by the end area 27 and the area 25 so that the text is not visible. In this condition, the pretzel 1 may be offered for sale or otherwise to be eaten.

Before eating the pretzel 1, the contestant may break open the band-shaped part by pulling apart the mutually-adhered end areas 26 and 27 in order to gain access to the concealed information 23. If a lucky number such as “B 1234” is involved, the contestant with the pretzel 1 may determine via access to an Internet site, such as “www.glücksbrezel.de”, or “www.luckypretzel.de”, whether this number is a winner, and what prize this lucky number B 1234 has won. The Internet address and other information regarding treatment of the information carrier 2 may, for example, be printed on the back side 22 of the band-shaped part between the end areas 26 and 27. It must be mentioned that the concealed information 23 may be configured in several ways, whereby the point is that the concealed information 23 only becomes visible when the two end areas 26 and 27 are pulled apart.

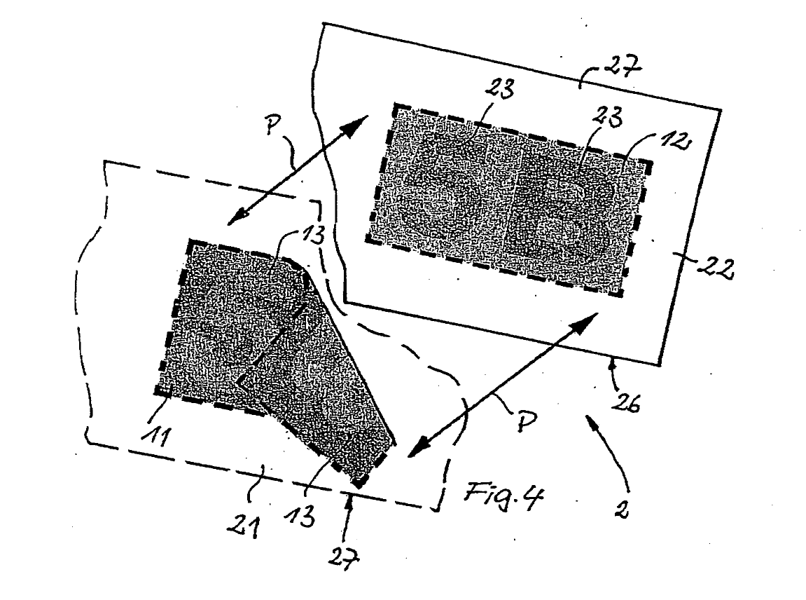

The concealed information 23 is preferably configured per FIG. 4. It consists of a first layer 11 and a second layer 12 that exactly coincide and adhere to each other when the concealed information 23, which in this case is the characters “5 B,” is concealed. The concealed information 23, or the digit “5” and the letter “B,” are contained in the surface of the first layer, and are separated from it by tear lines 13 (stamped or perforated lines). The second layer 12 includes on its side facing the first layer 11 a first color or a first pattern that is different from the second color or pattern of the digit “5” and of the letter “B” on the side facing away from the second layer 12. The color or pattern of the first layer 11 outside the tear line 13 preferably corresponds to the second color or pattern of the digit “5” and of the letter “B.” If, therefore, the first layer 11 and the second layer 12 are bonded together, the concealed information 23, i.e., the digit “5” and the letter “B,” themselves are not visible if the end area 27 of the band-shaped part are of a transparent material because the named letter and the named digit are still located within the area of the first layer 11 that is bonded with its side facing away from the second layer 12 to the end area 27 of the band-shaped part with adhesive. In this condition, the sides of the digit “5” and of the letter “B” facing toward the second layer 12 are bonded with adhesive to the area of the second layer 12.

The side of the second layer 12 facing away from the first layer 11 is bonded with adhesive to the end area 26 of the band-shaped part. In this condition, the information is not visible.

When the end areas 26 and 27 are pulled apart as in FIG. 4 (arrow P), the first layer 11 of the information carrier 23 bonded to the end area and the second layer 12 bonded to the end area 27 are separated from each other because of the low adhesion and separable bond between the inner surfaces of the first layer 11 and the second layer 12, whereby the areas of the concealed information 23 bonded to the second layer 12, i.e., of the digit “5” and of the letter “B,” is separated from the first part 11 along the tear lines 13, and the differing first and second colors or differing first and second patterns become visible.

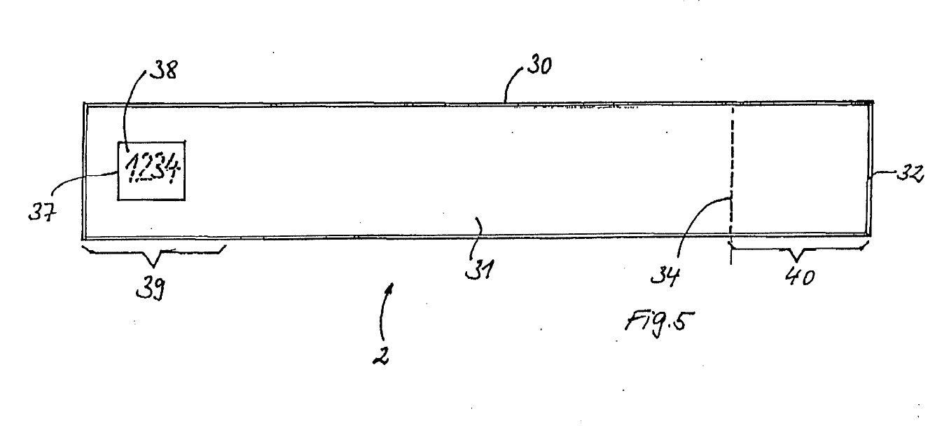

In the following in connection with FIG. 5, another embodiment of the invention will be explained in which the information carrier 2 possesses the shape of a band-shaped part 30 that is provided on its back side with an adhesive or bonding layer 32 onto which a protective film 31 is attached that may be released or pulled off that particularly includes a smooth surface on the side facing toward the adhesive layer 32. The concealed information 23 “1234” is printed on the back side of the end area 39 of the band-shaped part 30, whereby the protective layer 31 over it includes a field 38 covering the information “1234” that is separated from the rest of protective layer 31 by means of a stamped or tear line 37. The adhesive layer beneath the field 38 may be omitted. On the end area 40 of the band-shaped part 30 opposing the named end area 39 is located a separable area 35 that is connected with the protective layer 31 via a tear line 39. In order to attach the information carrier 2 to a pretzel, for example, the band-shaped part 30 is routed through an opening 11 of the pretzel, and the separable area 35 of the protective layer 31 is pulled away from the adhesive layer 32 of the other end area 40 of the band-shaped part 30 located below it, and is separable along the tear line 34 from the rest of the protective layer 31. The area of the adhesive layer 32 thus exposed is then adhered to the area of the protective layer 31 including the field 38 and covering the end area 39. In this condition, the band-shaped part 30 attached to a loop is secured to the pretzel 1 so that it may not be lost.

When the information carrier 2 is to be removed from the pretzel 1 before the pretzel 1 is consumed, both end areas 39 and 40 are pulled apart, whereby the field 38 covering the information “1234” adheres to the adhesive layer 32 of the other end area 40, and is separated from the protective layer along the tear line 37. During this, the information formerly invisible and covered by the field 38 becomes visible.

Instead of the continuous protective layer that extends over the entire length of the band-shaped part 30, the protective layer 31 may also be interrupted in the central area of the band-shaped part 30. This also applies to the adhesive layer 32. The entire front side of the band-shaped part, as well as the back side, may thus be imprinted with advertising slogans or similar.

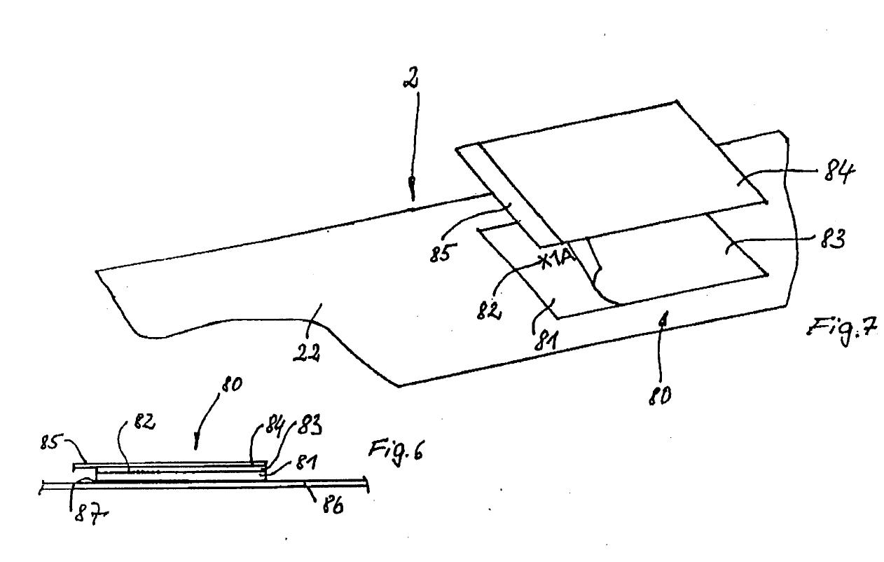

In the following in connection with FIGS. 6 and 7, another embodiment of the information carrier 2 will be explained that includes an adhesive label 80 that is mounted between the first and the second areas of the back side 22 of the information carrier 2.

The adhesive label 80 includes a carrier layer 81 that preferably may be pulled away from the carrier band 86 of a label roll presenting the self-adhesive labels 80. The carrier layer 81 therefore includes an adhesive layer 87 on its side facing toward the carrier band 86, by means of which it is attached to the carrier band 86 so that it may be removed. After removal of the carrier band 86, the carrier layer 81 is permanently attached to the first area of the back side 22 of the information carrier 2 in the manner visible from FIG. 7 so that it may not be removed.

The information 82 is positioned, preferably printed, on the side facing away from the first area of the carrier layer 81. The carrier layer 81 is preferably a polypropylene film.

An adhesive layer 83 is located on the side of the carrier layer 81 facing away from the back side 22, said adhesive layer covering the information 82, rendering it invisible.

A protective layer 84 is positioned on the side of the adhesive layer 83 facing away from the carrier layer 81. This protective layer 84 covers the adhesive layer 83, and preferably includes an area extending over the adhesive layer 83 on its one side that serves as a pull tab 85. The protective layer is preferably a silicone film such as silicone paper.

After adhering the carrier layer 81 to the first area of the back side 22, the protective layer 84 is pulled away from the adhesive layer 83. Subsequently, the second area of the back side 22 (not shown in FIG. 7) is preferably placed congruently onto the first area of the back side 22 whereby the second area is permanently and inseparably bonded to the adhesive layer 83. The adhesive layer 83 is so configured that it adheres to the second area to the extent that is pulled away from the carrier layer 81 when the two areas are separated from each other, whereby the concealed information 82 becomes visible. The information 82 may also be imprinted into the adhesive layer 87 if it consists of a transparent material. The adhesive layer 87 is preferably opaque.

There has thus been shown and described a novel information carrier with concealed information for mounting on an object which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Information carrier with concealed information for attachment to an object, wherein the information carrier comprises a front side and a back side, and wherein the back side of the information carrier has both a first area and a second area that may be removably attached to each other, the improvement wherein the first area of the information carrier includes the concealed information that is completely covered by the second area rendering it invisible when the two areas are attached to each other.

2. Information carrier as in claim 1, formed a band-shaped part, wherein the first area corresponds to a first end area of the band-shaped part and the second area corresponds to a second end area of the band-shaped part.

3. Information carrier as in claim 1, wherein the concealed information is in the form of at least one of a number, an image, a photograph, and text.

4. Information carrier as in claim 1, wherein the concealed information is printed onto the back side of the first area.

5. Information carrier as in claim 1, wherein the second area includes a third area with an adhesive that removably bonds the first area and the second end area with each other.

6. Information carrier as in claim 5, wherein the third area at least partially covers the concealed information.

7. Information carrier as in claim 1, wherein additional information is positioned in a fourth area between the first area and the second area.

8. Information carrier as in claim 7, wherein the additional information includes usage instructions for the information carrier.

9. Information carrier as in claim 1, wherein the information carrier is made of a material selected from the group consisting of paper, cardboard and plastic.

10. Information carrier as in claim 2, wherein the object is a baked item.

11. Information carrier as in claim 10, wherein the baked item is a pretzel, and wherein the band-shaped part is routed through an opening of the pretzel.

12. Information carrier as in claim 1, wherein the concealed information includes a first layer and a second layer positioned one congruently upon the other; wherein the areas of concealed information are positioned on the surface of the first layer and are separated from the rest of the first layer; wherein the areas of the concealed information with its side facing toward the second layer are at least partially adhered to the second layer; wherein the rest of the side of the first layer facing away from the second layer is at least partially adhered to the first area of the back side of the information carrier; wherein the side of the second layer facing away from the first layer is at least partially adhered at the second area of the back side of the information carrier, in such manner that, when the first and second areas are pulled apart, the areas of concealed information are extracted from the first layer along the tear lines and remain on the second layer.

13. Information carrier as in claim 12, wherein the areas of the concealed information on their side facing away from the second layer include at least one of a second color and a second pattern that is different from the side facing toward the first layer so that, after separation of the first layer and the second layer from each other, the areas of the concealed information become visible.

14. Information carrier as in claim 13, wherein the first layer includes said at least one of the second color and the second pattern outside the tear lines on the side facing toward the first area.

15. Information carrier as in claim 1, wherein an adhesive layer is positioned on the back side of the band-shaped part in at least one end area and the other end area of the band-shaped part; wherein the concealed information is positioned on one end area of the band-shaped part; wherein the one end area is covered by a protective layer that includes a field above the concealed information, separable along a tear line from the rest of the protective layer; wherein the other end area is covered by an additional protective layer; wherein an additional protective layer is positioned on the adhesive layer; and wherein the other end area is adhered to the adhesive layer and the field of the end area after removing the additional protective layer with the adhesive layer such that, when the first and the second end areas, with the field are separated from the protective layer of the first end area along the tear line the concealed information becomes visible.

16. Information carrier as in claim 15, wherein the adhesive layer of the one end area and the adhesive layer of the other end area of the band-shaped part are formed as one continuous adhesive layer that extends substantially along the entire length of the band-shaped part, and wherein the one protective layer of the one end area and the additional protective layer of the other end area are formed by a single protective layer that is adhered using the adhesive layer substantially along the entire length of the band-shaped part.

17. Information carrier as in claim 15, wherein the concealed information is imprinted onto the back side of the one end area of the band-shaped part.

18. Information carrier as in claim 15, wherein the protective layer of the one end area and the protective layer of the other end area includes a smooth layer on the side facing toward the adhesive layer of the one end area.

19. Information carrier as in claim 17, wherein the entire protective layer includes a smooth layer on its side facing toward the adhesive layer of the band-shaped part.

20. Information carrier as in claim 18, wherein the adhesive layer is omitted in the area of the field.

21. Information carrier as in claim 15, wherein the band-shaped part is made of a material selected from the group consisting of paper, cardboard and plastic.

22. Information carrier as in claim 15, wherein at least the one end area bearing the concealed information of the band-shaped part and at least the field of the protective layer of the one end area is not transparent.

23. Information carrier as in claim 15, wherein the field with its side facing toward the back side of the one end area is less strongly adhered than is the other side to the adhesive layer of the other end area.

24. Information carrier as in claim 15, wherein an adhesive label bearing the information is positioned between the first and second area of the back side of the information carrier that includes a carrier layer that may be adhered by means of an adhesive layer, said carrier layer being provided with an adhesive layer on its side facing away from the adhesive layer that covers the information, and wherein the adhesive layer is provided with a removable protective layer on its side facing away from the carrier layer such that the adhesive layer after removal of the protective layer is permanently adhered to the second area of the back side, whereby when the two areas are separated from each other, the adhesive layer is separated from the carrier layer, and the information becomes visible.

25. Information carrier as in claim 24, wherein the information is printed onto the side of the carrier layer facing toward the opaque adhesive layer.

26. Information carrier as in claim 24, wherein the information is imprinted into the adhesive layer, and wherein the carrier layer is transparent.

27. Information carrier as in claim 24, wherein the adhesive layer is opaque.

28. Information carrier as in claim 24, wherein the protective layer is a silicone layer.

29. Information carrier as in claim 24, wherein the carrier layer is a polypropylene layer.

30. Information carrier as in claim 24, wherein the protective layer includes a pull tab extending on a side over the adhesive layer.

31. Information carrier as in claim 24, wherein the adhesive layer of the self-sticking label is positioned on a label band so that it may be removed.

32. Information carrier as in claim 7, wherein the additional information is an advertisement.

33. Information carrier as in claim 15, wherein the one protective layer of the one end area and the protective layer of the other end area includes a smooth layer on the side facing toward the adhesive layer of the other end area.

34. Information carrier as in claim 24, wherein the protective layer is a silicone paper.
